(19) United States
(12) Patent Application Publication
(10) Pub. No.: US 2025/0356754 A1
(43) Pub. Date: Nov. 20, 2025

(54) DATA PROCESSING DEVICE, DATA PROCESSING METHOD, AND STORAGE MEDIUM STORING DATA PROCESSING PROGRAM

(71) Applicant: DENSO CORPORATION, Kariya-city (JP)

(72) Inventors: Masato MIYAKE, Kariya-city (JP); Makiko Tauchi, Kariya-city (JP)

(21) Appl. No.: 19/276,217

(22) Filed: Jul. 22, 2025

Related U.S. Application Data
(63) Continuation of application No. PCT/JP2024/001619, filed on Jan. 22, 2024.

(30) Foreign Application Priority Data
Jan. 27, 2023 (JP) 2023-011005

(51) Int. Cl. G08G 1/01

(52) U.S. Cl. CPC G08G 1/0108; G08G 1/0125

(57) ABSTRACT

A data processing device, a data processing method, or a non-transitory computer-readable storage medium storing a data processing program acquires first data that is data related to a vehicle by a preset first acquisition manner, acquires second data that is data related to an object other than the vehicle by a preset second acquisition manner, generates first standardization data including a first data ID and a first standard data value obtained by normalizing a value of the first data, and generates second standardization data including a second data ID and a second standard data value obtained by normalizing a value of the second data.

### CROSS REFERENCE TO RELATED APPLICATIONS

The present application is a continuation application of International Patent Application No. PCT/JP2024/001619 filed on Jan. 22, 2024, which designated the U.S. and claims the benefit of priority from Japanese Patent Application No. 2023-011005 filed on Jan. 27, 2023. The entire disclosures of all of the above applications are incorporated herein by reference.

### TECHNICAL FIELD

The present disclosure relates to a data processing device, a data processing method, and a data processing program for acquiring vehicle data.

### BACKGROUND

As a comparative example, a digital twin simulation has been known, and reproduces a real-world vehicle state in a virtual space by collecting vehicle data from a vehicle.

### SUMMARY

According to an aspect of the present disclosure, a data processing device includes at least one of (i) a circuit and (ii) a processor with a memory storing computer program code executable by the processor, the at least one of the circuit and the processor configured to cause the data processing device to: acquire first data that is data related to a vehicle by a preset first acquisition manner; acquire second data that is data related to an object other than the vehicle by a preset second acquisition manner; generate first standardization data including a first data ID and a first standard data value obtained by normalizing a value of the first data; and generate second standardization data including a second data ID and a second standard data value obtained by normalizing a value of the second data.

### BRIEF DESCRIPTION OF THE DRAWINGS

FIG. 1 is a block diagram that illustrates a configuration of a data processing device.

FIG. 2 is a flowchart showing a format commonization process.

FIG. 3 is a diagram illustrating a common format.

FIG. 4 is a flowchart showing a data extraction process.

FIG. 5 is a diagram illustrating a storage format of a raw data ID and a raw data value.

FIG. 6 is a flowchart showing a data standardization process.

FIG. 7 is a diagram illustrating a storage format of a standard data ID and a standard data value.

FIG. 8 is a flowchart showing data transmission process.

### DETAILED DESCRIPTION

In recent years, mobility services utilizing vehicle data have been actively developed. In particular, in a logistics field, vehicle data such as traveling data, fuel consumption, and battery information are required to be collected in order to conform to laws and regulations or improve the efficiency of transportation and delivery.

For example, it is considered that static information such as a battery manufacturer and specifications may be obtained by reading and collecting the QR code or barcode attached to a battery. Further, dynamically changing information such as a battery use history may be repeatedly collected from the vehicle via wireless communication such as BLE and Wi-Fi, and recorded. In this way, various data collection methods are considered. The QR code is a registered trademark. The BLE is an abbreviation for Bluetooth Low Energy. The Bluetooth is a registered trademark. The Wi-Fi is a registered trademark.

As a result of detailed study by the inventors, it has been found that when a format of the collection data is different for each data collection system, it is difficult to handle the data when using vehicle data.

The present disclosure facilitates the use of data.

According to one aspect of the present disclosure, a data processing device includes a first acquisition portion, a second acquisition portion, a standardization processing portion, a data storage, and a data transmission portion.

The first acquisition portion is configured to acquire first data that is data related to a vehicle by a preset first acquisition manner from the vehicle.

The second acquisition portion is configured to acquire second data that is data related to an object other than the vehicle by a preset second acquisition manner from the object.

The standardization processing portion is configured to generate first standardization data including a first data ID for identifying the first data acquired by the first acquisition portion and a first standard data value obtained by normalizing a value of the first data, and generate second standardization data including a second data ID for identifying the second data acquired by the second acquisition portion and a second standard data value obtained by normalizing a value of the second data.

The data storage stores the first standardization data and the second standardization data.

The data transmission portion is configured to transmit the first standardization data and the second standardization data stored in the data storage when a preset data transmission condition is satisfied for each of the first standardization data and the second standardization data.

The data processing device configured in such a manner in the present disclosure converts one data into a format including a data ID and a data value, and normalizes multiple data received by different acquisition methods to generate multiple standardization data. Therefore, it is possible to provide data in a common data format that is independent of the acquisition method, and it is possible to ease the use of the data.

Another aspect of the present disclosure is a data processing method executed by a data processing device.

The data processing method of the present disclosure acquires first data that is data related to the vehicle from the vehicle by a preset first acquisition manner, and second data that is data related to the vehicle is acquired from an object other than the vehicle by a preset second acquisition manner.

The data processing method of the present disclosure includes generating first standardization data including a first data ID for identifying the acquired first data and a first standard data value obtained by normalizing a value of the first data, and generating second standardization data including a second data ID for identifying the acquired second data and a second standard data value obtained by normalizing a value of the second data.

The data processing method of the present disclosure includes transmitting the first standardization data and the second standardization data when a preset data transmission condition is satisfied for each of the first standardization data and the second standardization data.

The data processing method of the present disclosure is a method executed by the data processing device of the present disclosure. By executing the method, the same effects as those of the data processing device of the present disclosure can be obtained.

Further, another aspect of the present disclosure is a data processing program for causing a computer to serve as a first acquisition portion, a second acquisition portion, a standardization processing portion, a data storage, and a data transmission portion.

The computer controlled by the data processing program of the present disclosure can configure a part of the data processing device of the present disclosure, and can obtain the same effects as the data processing device of the present disclosure.

Hereinafter, an embodiment of the present disclosure will be described with reference to the drawings.

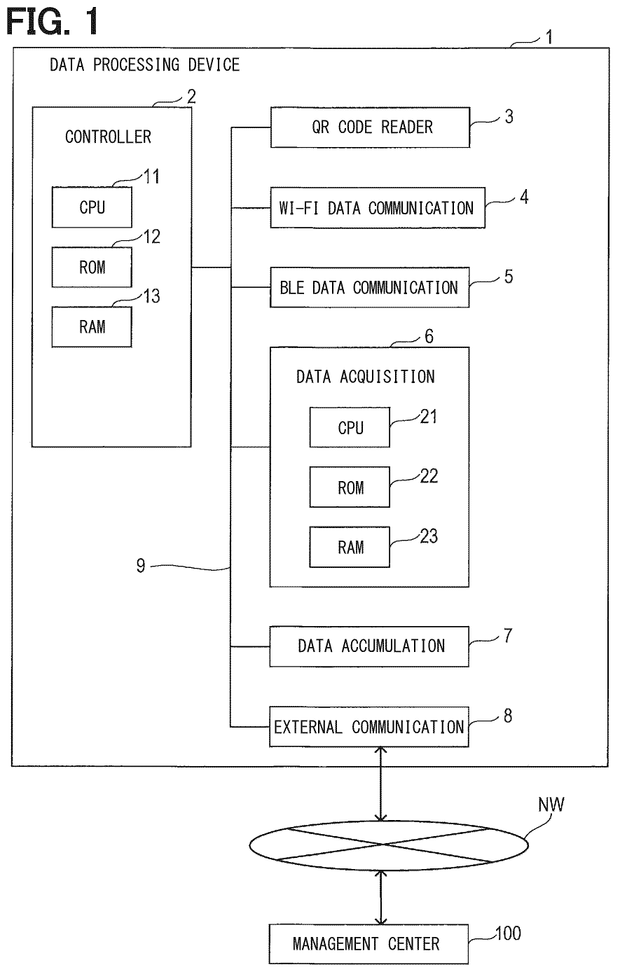

A data processing device 1 of the present embodiment is a smartphone possessed by a driver of a vehicle, and as shown in FIG. 1, includes a controller 2, a QR code reader 3, a Wi-Fi communication portion 4, a BLE communication portion 5, a data acquisition portion 6, a data accumulation portion 7, an external communication portion 8, and a bus 9.

The controller 2 is an electronic control portion mainly including a microcomputer with a CPU 11, a ROM 12, a RAM 13, and the like. Various functions of the microcomputer are implemented by the CPU 11 executing a program stored in a non-transitory tangible storage medium. In this example, the ROM 12 corresponds to the non-transitory tangible storage medium in which the program is stored. Further, by executing this program, a method corresponding to the program is executed. A part or all of the functions to be executed by the CPU 11 may be configured in hardware by one or multiple ICs or the like. The number of microcomputers included in the controller 2 may be one or more.

The QR code reader 3 includes a camera (not shown) and reads the QR code by capturing the QR code with the camera. The QR code reader 3 decrypts the QR code read by the camera, and outputs the data obtained by decryption as QR code data. In the present embodiment, the QR code reader 3 reads the QR code attached to a battery mounted on a vehicle.

The QR code data includes one or more raw data IDs for identifying battery data (for example, battery manufacturer and specifications) related to the battery, and one or more raw data values indicating the value of the battery data corresponding to each of one or more raw data IDs.

The Wi-Fi communication portion 4 performs short-range wireless communication by a manner conforming to the Wi-Fi standard. The Wi-Fi communication portion 4 outputs the received data as Wi-Fi data. In the present embodiment, the Wi-Fi communication portion 4 performs data communication with a charging device that charges the battery of the vehicle.

The Wi-Fi data includes one or more raw data IDs for identifying charging device data (for example, charging power) related to the charging device, and one or more raw data values indicating values of charging device data corresponding to one or more raw data IDs.

The BLE communication portion 5 performs short-range wireless communication by a manner conforming to BLE, which is an extension specification of Bluetooth. The BLE communication portion 5 outputs the received data as BLE data. In the present embodiment, the BLE communication portion 5 performs data communication with multiple ECUs mounted on the vehicle. The ECU is an abbreviation for Electronic Control portion.

The BLE data includes one or more raw data IDs for identifying vehicle data (for example, vehicle speed, engine speed) related to the vehicle, and one or more raw data values indicating the values of the vehicle data corresponding to each of the one or more raw data IDs.

The data acquisition portion 6 is an electronic control portion mainly including a microcomputer with a CPU 21, a ROM 22, a RAM 23, and the like. Various functions of the microcomputer are implemented by the CPU 21 executing a program stored in a non-transitory tangible storage medium. In this example, the ROM 22 corresponds to the non-transitory tangible storage medium in which the program is stored. A method corresponding to the program is executed by executing the program. A part or all of the functions to be executed by the CPU 21 may be configured in hardware by one or multiple ICs or the like. Further, the number of microcomputers included in the data acquisition portion 6 may be one or more.

The data accumulation portion 7 is a storage device for storing various data.

The external communication portion 8 performs data communication with a management center 100 via a wide area wireless communication network NW. The management center 100 is a device that acquires vehicle data related to multiple vehicles corresponding to each of the multiple data processing devices 1 from each of the multiple data processing devices 1, and manages the multiple vehicles.

The bus 9 connects the controller 2, the QR code reader 3, the Wi-Fi communication portion 4, the BLE communication portion 5, the data acquisition portion 6, the data accumulation portion 7, and the external communication portion 8 so as to input and output data to and from each other.

Next, a procedure of the format commonization process executed by the data acquisition portion 6 will be described. The format commonization process is a process repeatedly executed during operation of the data processing device 1.

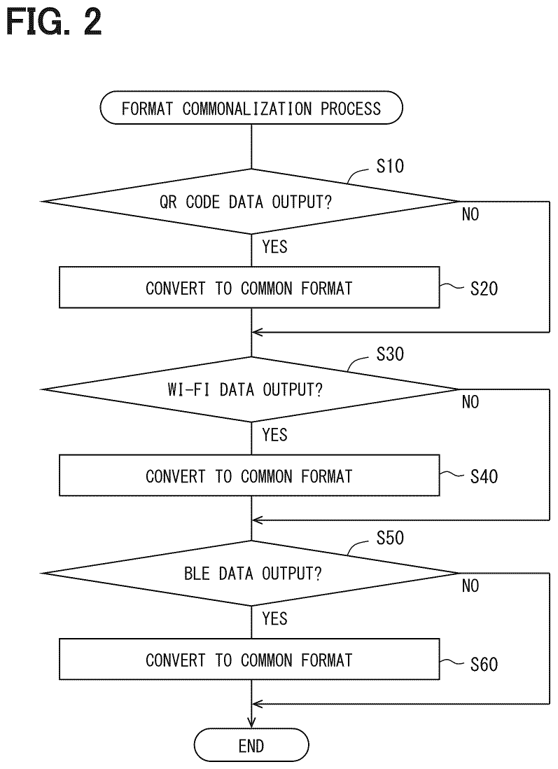

When the format commonization process is executed, as shown in FIG. 2, the CPU 21 of the data acquisition portion 6 first determines whether the QR code data is output from the QR code reader 3 in S10. Here, when the QR code data is not output from the QR code reader 3, the CPU 21 shifts to S30.

On the other hand, when the QR code data is output from the QR code reader 3, the CPU 21 acquires the QR code data output from the QR code reader 3 in S20, converts this QR code data into a common format described later, and generates the common formatted data, and the process shifts to S30.

When the process shifts to S30, the CPU 21 determines whether the Wi-Fi data is output from the Wi-Fi communication portion 4. Here, when the Wi-Fi data is not output from the Wi-Fi communication portion 4, the CPU 21 shifts to S50.

On the other hand, when the Wi-Fi data is output from the Wi-Fi communication portion 4, the CPU 21 acquires the Wi-Fi data from the Wi-Fi communication portion 4 in S40, converts this Wi-Fi data into the above-described common format, and generates the common formatted data, and the process shifts to S50.

When the process shifts to S50, the CPU 21 determines whether the BLE data is output from the BLE communication portion 5. Here, when the BLE data is not output from the BLE communication portion 5, the CPU 21 ends the format commonization process.

On the other hand, when the BLE data is output from the BLE communication portion 5, the CPU 21 acquires the BLE data from the BLE communication portion 5 in S60, converts this BLE data into the above-described common format, and generates the common formatted data, and ends the format commonization process.

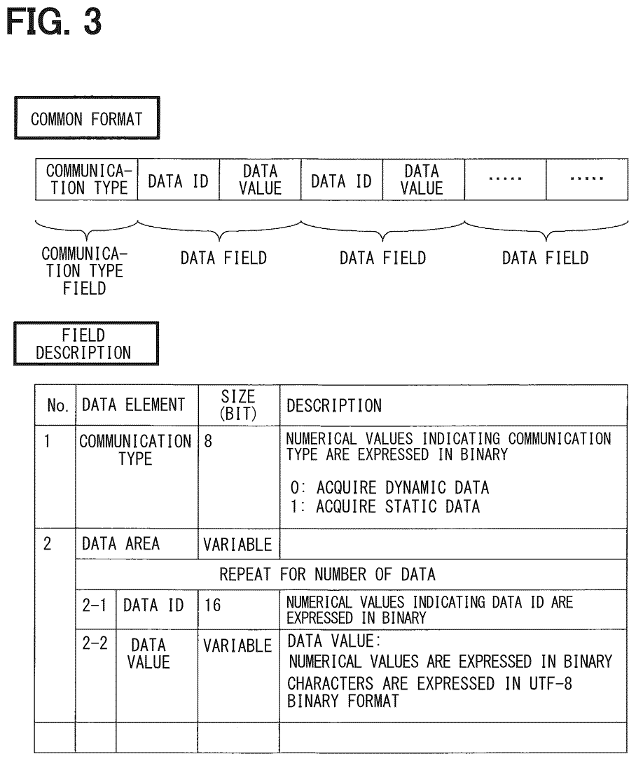

As shown in FIG. 3, the common formatted data includes one communication type field and one or more data fields.

The communication type field stores communication type information indicating a communication type. The data size of the communication type information is 8 bits. The communication type information is set to 0 or 1 depending on the communication type. When the communication type information is set to 0, the data in the data field is dynamic data. When the communication type information is set to 1, the data in the data field is static data. The dynamic data is data whose value changes in a short time, and static data is data whose value does not change in a short time. In other words, the dynamic data is more likely to change than the static data. In the present embodiment, the Wi-Fi data and the BLE data are dynamic data, and the QR code data is static data.

One data field stores one data ID and one data value. The data size of one data ID is 16 bytes. The data size of one data value is variable. When the data value is a numerical value, the data value is expressed in binary. When the data value is a character, it is expressed in the UTF-8 format.

In S20 described above, the CPU 21 generates one or more data fields by extracting corresponding raw data values from the QR code data for each of one or more raw data IDs included in the acquired QR code data. Further, the CPU 21 generates a communication type field in which the communication type information is set to 1. Then, the CPU 21 generates common formatted data by connecting one communication type field and one or more data fields.

In S40 described above, the CPU 21 generates one or more data fields by extracting the corresponding raw data value from the Wi-Fi data for each of one or more raw data IDs included in the acquired Wi-Fi data. Further, the CPU 21 generates a communication type field in which the communication type information is set to 0. Then, the CPU 21 generates common formatted data by connecting one communication type field and one or more data fields.

In S60 described above, the CPU 21 generates one or more data fields by extracting corresponding raw data values from the BLE data for each of one or more raw data IDs included in the acquired BLE data. Further, the CPU 21 generates a communication type field in which the communication type information is set to 0. Then, the CPU 21 generates common formatted data by connecting one communication type field and one or more data fields.

Next, a procedure of the data extraction process executed by the controller 2 will be described. The data extraction process is a process repeatedly executed during the operation of the data processing device 1.

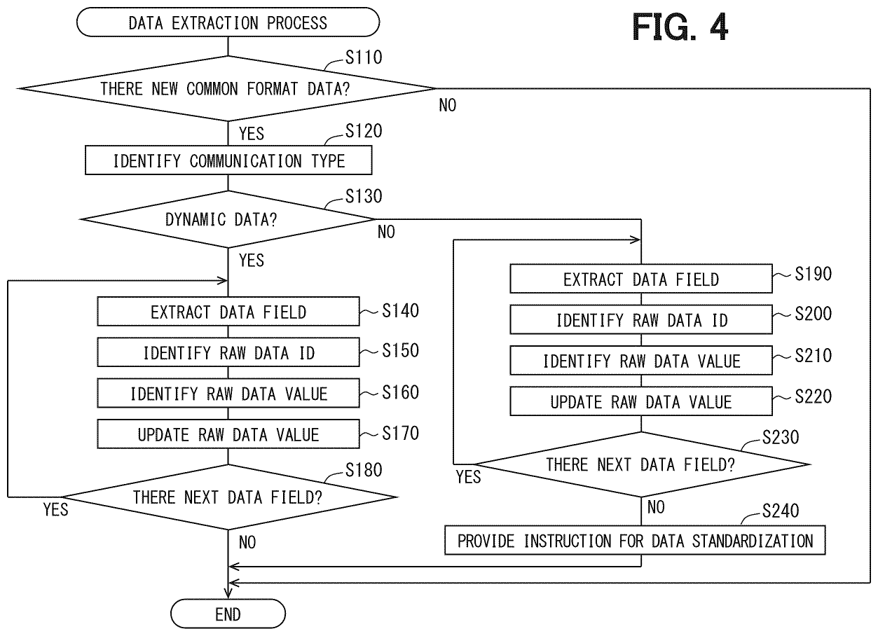

When the data extraction process is executed, as shown in FIG. 4, the CPU 11 of the controller 2 first determines whether the data acquisition portion 6 has generated the new common formatted data in S110. Here, when the data acquisition portion 6 does not generate the new common formatted data, the CPU 11 ends the data extraction process.

On the other hand, when the data acquisition portion 6 generates new common formatted data, the CPU 11 acquires the new common formatted data in S120 and extracts the communication type information from the acquired common formatted data to identify the communication type.

In S130, the CPU 11 determines whether the data included in the acquired common formatted data is dynamic data based on the identification result in S120. Specifically, when the communication type information of the common formatted data is set to 0, the CPU 11 determines that the data included in the common formatted data is dynamic data. On the other hand, when the communication type information of the common formatted data is set to 1, the CPU 11 determines that the data included in the common formatted data is static data.

Here, when the data included in the common formatted data is dynamic data, in S140, the CPU 11 extracts, in order, one data field for which the raw data ID and the raw data value have not been identified from the top of the common formatted data from the common formatted data acquired in S120.

In S150, the CPU 11 identifies the raw data ID of the data field extracted in S140.

In S160, the CPU 11 identifies the raw data value of the data field extracted in S140.

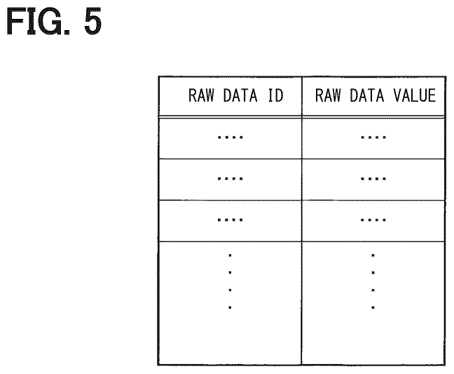

In S170, the CPU 11 updates the raw data value identified in S160. Specifically, as shown in FIG. 5, the CPU 11 associates the raw data ID identified in S150 with the raw data value identified in S160 and stores it in the RAM 13. When the raw data ID identified in S150 is not stored in the RAM 13, the CPU 11 stores the raw data ID identified in S150 and the raw data value identified in S160 in the RAM 13. On the other hand, when the raw data ID identified in S150 is already stored in the RAM 13, the CPU 11 overwrites the raw data value identified in S160 in the storage area in which the raw data value corresponding to the raw data ID identified in S150 is stored.

As shown in FIG. 4, in S180, the CPU 11 determines whether the next data field is behind the data field extracted in S140. Here, when the next data field exists behind the data field extracted in S140, the CPU 11 shifts to S140. On the other hand, when there is no next data field behind the data field extracted in S140, the CPU 11 ends the data extraction process.

In S130, when the data included in the common formatted data is not the dynamic data, the CPU 11 extracts one data field in S190 similarly to S140.

In S200, similarly to S150, the CPU 11 identifies the raw data ID of the data field extracted in S190.

In S210, similarly to S160, the CPU 11 identifies the raw data value of the data field extracted in S190.

In S220, the CPU 11 updates the raw data value identified in S210 similarly to S170.

In S230, the CPU 11 determines whether the next data field exists behind the data field extracted in S190. Here, when the next data field exists behind the data field extracted in S190, the CPU 11 shifts to S190. On the other hand, when there is no next data field behind the data field extracted in S190, the CPU 11 executes the data standardization instruction in S240 and ends the data extraction process.

Next, a procedure of the data standardization process executed by the controller 2 will be described. The data standardization process is a process repeatedly executed during the operation of the data processing device 1.

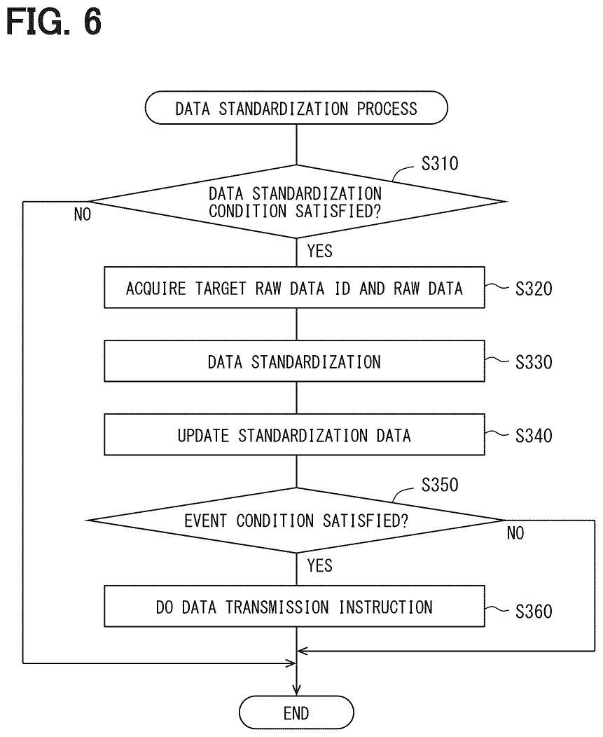

When the data standardization process is executed, the CPU 11 of the controller 2 first determines whether a predetermined data standardization condition is satisfied in S310, as shown in FIG. 6. In the present embodiment, the data standardization condition includes a first periodic standardization condition, a second periodic standardization condition, a third periodic standardization condition, a first event standardization condition, and a second event standardization condition.

The first periodic standardization condition is that a first cycle (for example, one second) has elapsed since the first periodic standardization condition was satisfied last time. The second periodic standardization condition is that a second cycle (for example, one minute) has elapsed since the second periodic standardization condition was satisfied last time. The third periodic standardization condition is that a third cycle (for example, one hour) has elapsed since the third periodic standardization condition was satisfied last time.

The first event standardization condition is that the controller 2 executes the data standardization instruction. The second event standardization condition is that the raw data value corresponding to the raw data ID that matches the preset second event target data ID changes.

Here, when the data standardization condition is not satisfied, the CPU 11 ends the data standardization process. On the other hand, when the data standardization condition is satisfied, in S320, the CPU 11 acquires one or more raw data IDs preset for the satisfied data standardization condition and one or more raw data values corresponding to one or more raw data IDs.

In S330, the CPU 11 generates the standardization data by performing data standardization using the one or more raw data IDs acquired in S320 and the one or more raw data values. The standardization data includes one standard ID and one standard data value. Specifically, the CPU 11 refers to a standardization table stored in the ROM 12 to convert one or more raw data IDs and one or more raw data values into one or more standard IDs and one or more standard data values.

The standardization table includes multiple pieces of normalization information and multiple pieces of semantic information.

The normalization information is information for normalizing raw data values so that the same physical quantity has the same value regardless of the vehicle type and vehicle manufacturer.

The normalization information includes ID conversion information for converting raw data IDs into standard IDs and data value conversion information for converting raw data values into standard data values.

The ID conversion information is information for converting data IDs so that the same type has the same value regardless of the vehicle type and vehicle manufacturer. For example, the raw data ID of “vehicle speed” differs depending on the vehicle type and vehicle manufacturer. On the other hand, the raw data ID of the “vehicle speed” is converted into the same standard ID regardless of the vehicle type and vehicle manufacturer based on the ID conversion information.

The data value conversion information includes, for example, “significant digits number”, “resolution”, “offset”, and “unit”. The “significant digits number” is information indicating the significant digits number of the standard data value. The “resolution” is information indicating a numerical value per bit. The “offset” indicates the offset amount of the numerical value of the data. The “unit” indicates the unit of the data.

The data value conversion information includes, for example, a correspondence table between the raw data value and the standard data value. For example, the correspondence table associates the raw data values “0”, “1”, “2”, and “3” with the shift positions “P”, “R”, “N”, and “D”, respectively.

The semantic information is information (for example, an arithmetic expression, a conversion table) for converting the normalized raw data value into meaningful vehicle data. The raw data value before normalization may be used for the semantic information.

The semantic information includes a “standard ID” corresponding to the standard data value calculated by the conversion, and a conversion expression or conversion table for converting the raw data value to the standard data value. The conversion expression is, for example, an expression that converts a raw data value indicating a “steering angle” into a standard data value indicating a “steering angle” by subtracting a raw data value indicating a “steering zero point”.

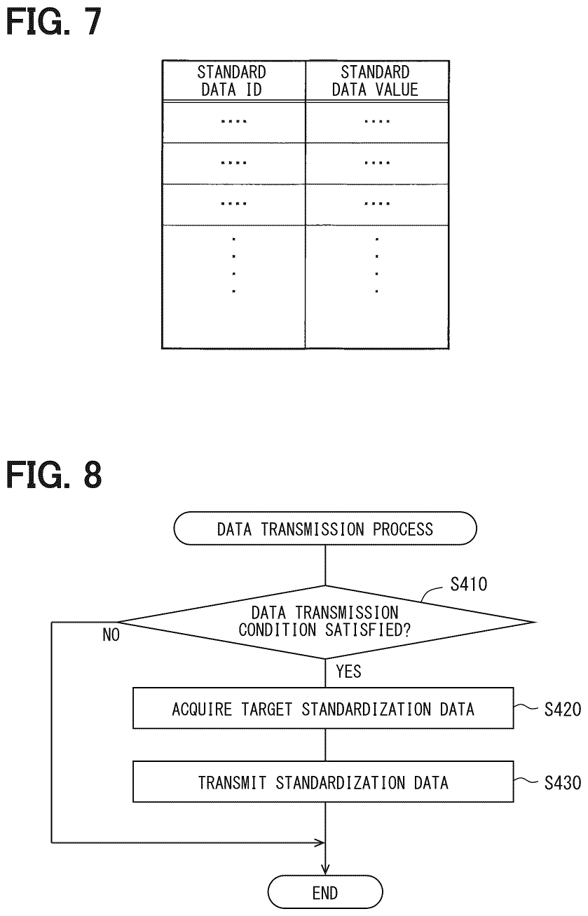

In S340, the CPU 11 updates the standardization data generated in S330. Specifically, as shown in FIG. 7, the CPU 11 associates the standard ID and the standard data value with the standardization data generated in S330 and stores them in the data accumulation portion 7. When the standard ID of the standardization data generated in S330 is not stored in the data accumulation portion 7, the CPU 11 stores the standard ID and the standard data value of the standardization data generated in S330 in the data accumulation portion 7. On the other hand, when the standard ID of the standardization data generated in S330 is stored in the data accumulation portion 7, the CPU 11 overwrites the standard data value of the standardization data generated in S330 in the storage area in which the standard data value corresponding to the standard ID of the standardization data generated in S330 is stored.

As shown in FIG. 6, in S350, the CPU 11 determines whether the above-described first event standardization condition or the above-described second event standardization condition is satisfied. Here, when the first event standardization condition and the second event standardization condition are not satisfied, the CPU 11 ends the data standardization process. On the other hand, when the first event standardization condition or the second event standardization condition is satisfied, the CPU 11 executes the data transmission instruction in S360 and ends the data standardization process.

Next, a procedure of the data transmission process executed by the controller 2 will be described. The data transmission process is a process repeatedly executed during the operation of the data processing device 1.

When the data transmission process is executed, the CPU 11 of the controller 2 first determines whether a predetermined data transmission condition is satisfied in S410, as shown in FIG. 8. In the present embodiment, the data transmission condition includes a first periodic transmission condition, a second periodic transmission condition, a third periodic transmission condition, and an event transmission condition.

The first periodic transmission condition is that a first cycle (for example, one second) has elapsed since the first periodic transmission condition was satisfied last time. The second periodic transmission condition is that a second cycle (for example, one minute) has elapsed since the second periodic transmission condition was satisfied last time. The third periodic transmission condition is that a third cycle (for example, one hour) has elapsed since the third periodic transmission condition was satisfied last time. The event transmission condition is that the controller 2 executes the data transmission instruction.

Here, when the data transmission condition is not satisfied, the CPU 11 ends the data transmission process. On the other hand, when the data transmission condition is satisfied, the CPU 11 acquires, from the data accumulation portion 7, one or more standardization data preset for the satisfied data standardization condition in S420.

In S430, the CPU 11 causes the external communication portion 8 to execute a process of transmitting the one or more standardization data acquired in S420 to the management center 100, and ends the data transmission process.

The data processing device 1 configured as described above includes the BLE communication portion 5, the Wi-Fi communication portion 4, the QR code reader 3, the data acquisition portion 6, the controller 2, the data accumulation portion 7, and the external communication portion 8.

The BLE communication portion 5 acquires vehicle data related to the vehicle by performing short-range wireless communication in a manner conforming to BLE from the vehicle.

The Wi-Fi communication portion 4 acquires charging device data related to the charging device from the charging device by performing short-range wireless communication using a manner conforming to the Wi-Fi standard.

The QR code reader 3 acquires battery data related to the battery from the battery by reading the QR code attached to the battery mounted on the vehicle.

The data acquisition portion 6 and the controller 2 generate standardization data for the vehicle data acquired by the BLE communication portion 5. The standardization data includes a standard ID for identifying the vehicle data and a standard data value obtained by normalizing the value of the vehicle data.

The data acquisition portion 6 and the controller 2 generate standardization data for the charging device data acquired by the Wi-Fi communication portion 4. The standardization data includes a standard ID for identifying the charging device data and a standard data value obtained by normalizing the value of the charging device data.

The data acquisition portion 6 and the controller 2 generate standardization data including a standard ID for identifying the battery data and a standard data value obtained by normalizing the value of the battery data for the battery data acquired by the QR code reader 3.

The data accumulation portion 7 may store the standard data value and the standardization data.

The controller 2 and the external communication portion 8 transmit the standardization data stored in the data accumulation portion 7 to the management center 100 when a preset data transmission condition is satisfied.

Such a data processing device 1 converts one data into a format including a data ID and a data value, and normalizes multiple data acquired by different acquisition methods to generate multiple standardization data. Therefore, it is possible to provide data in a common data format that is independent of the acquisition manner, and it is possible to ease the use of the data.

In the data processing device 1, the data acquisition portion 6 that generates the common formatted data is separated from other components (i.e., the controller 2, the QR code reader 3, the Wi-Fi communication portion 4, the BLE communication portion 5, the data accumulation portion 7, and the external communication portion 8) that constitute the data processing device 1. Therefore, when adding the new acquisition manner, the data processing device 1 only needs to add a new data communication portion (for example, the QR code reader 3, the Wi-Fi communication portion 4, the BLE communication portion 5, and the like) and change the configuration of the data acquisition portion 6. Thereby, it is possible to easily extend the data processing device 1.

Further, the data acquisition portion 6 determines whether each of the vehicle data acquired by the BLE communication portion 5, the charging device data acquired by the Wi-Fi communication portion 4, and the battery data acquired by the QR code reader 3 is dynamic data or static data, and sets communication type information indicating whether it is dynamic data or static data to the standardization data. Specifically, the data acquisition portion 6 adds the communication type information to the common formatted data to set the communication type information to the standardization data.

The controller 2 and the external communication portion 8 transmit the standardization data when the data transmission condition set according to the communication type information is satisfied. In the present embodiment, any one of the first periodic transmission condition, the second periodic transmission condition, and the third periodic transmission condition is set as the data transmission condition for the dynamic data, and the event transmission condition is set for the static data.

Such a data processing device 1 can transmit dynamic data whose data value changes in a short time to the management center 100 at an appropriate timing according to the frequency with which the data value changes. Thereby, the management center 100 can manage changes in dynamic data. Further, even in a case of the static data of which data value does not change in a short time, the data processing device 1 can transmit the data to the management center 100 at an appropriate timing according to the frequency with which the data value changes. Thereby, the data processing device 1 can prevent the occurrence of waste in transmitting the static data to the management center 100 even though the data value of the static data does not change.

Further, when the communication type information indicates static data, the data transmission condition (i.e., event transmission condition) is set to transmit the data immediately after the standardization data corresponding to the static data is generated. Thereby, the data processing device 1 can provide the standardization data corresponding to the static data to the management center 100 at the earliest possible timing.

Further, when the communication type information indicates dynamic data, the data transmission condition (i.e., first periodic transmission condition, second periodic transmission condition, and third periodic transmission condition) is set to transmit the standardization data corresponding to the dynamic data every time a preset transmission cycle (i.e., first cycle, second cycle, and third cycle) elapses. Thereby, the data processing device 1 can provide the standardization data to the management center 100 at any timing that is independent of the data acquisition frequency for each data acquisition manner of the QR code reader 3, the Wi-Fi communication portion 4, and the BLE communication portion 5.

Further, a raw data ID for identifying the vehicle data is added to the vehicle data acquired by the BLE communication portion 5. The raw data ID for identifying the charging device data is added to the charging device data acquired by the Wi-Fi communication portion 4. The raw data ID for identifying the battery data is added to the battery data acquired by the QR code reader 3.

Then, the data acquisition portion 6 converts the vehicle data acquired by the BLE communication portion 5 into common formatted data including the raw data ID and the raw data value indicating the value of the vehicle data. The data acquisition portion 6 converts the charging device data acquired by the Wi-Fi communication portion 4 into common formatted data including the raw data ID and the raw data value indicating the value of the charging device data. The data acquisition portion 6 converts the battery data acquired by the QR code reader 3 into common formatted data including the raw data ID and the raw data value indicating the value of the battery data.

The controller 2 generates the standardization data by normalizing the raw data value included in the common formatted data.

Such a data processing device 1 can generate the standardization data at any timing that is independent of the data acquisition frequency for each data acquisition manner of the QR code reader 3, the Wi-Fi communication portion 4, and the BLE communication portion 5.

Further, the data acquisition portion 6 determines whether the vehicle data acquired by the BLE communication portion 5 is dynamic data or static data, and adds communication type information indicating whether it is dynamic data or static data to the common formatted data. The data acquisition portion 6 determines whether the charging device data acquired by the Wi-Fi communication portion 4 is dynamic data or static data, and adds communication type information indicating whether it is dynamic data or static data to the common formatted data. The data acquisition portion 6 determines whether the battery data acquired by the QR code reader 3 is dynamic data or static data, and adds communication type information indicating whether it is dynamic data or static data to the common formatted data.

Further, the data transmission condition of the static data is set to transmit data each time after the standardization data that is a target of the data transmission condition is generated. Thereby, the data processing device 1 can provide the standardization data corresponding to the static data to the management center 100 at the earliest possible timing.

Further, even in a case where the standardization data that is the target of the data transmission condition is generated, when the standard data value included in the standardization data does not change, the data transmission condition of the static data is set to prohibit transmission. Thereby, the data processing device 1 can prevent the occurrence of waste in transmitting the static data to the management center 100 even though the data value of the static data does not change.

In the embodiment described above, the BLE communication portion 5 corresponds to a first acquisition portion, the Wi-Fi communication portion 4 and the QR code reader 3 correspond to a second acquisition portion, and S10 to S360 correspond to processes as a standardization processing portion.

The data accumulation portion 7 corresponds to a data storage, and S410 to S430 correspond to processes as a data transmission portion.

Further, the manner conforming to the BLE corresponds to a first acquisition manner, the vehicle data corresponds to first data, the manner conforming to the Wi-Fi standard corresponds to a second acquisition manner, the charging device data corresponds to second data, the reading of the QR code corresponds to second acquisition manner, and the battery data corresponds to second data. The second data is data related to an object other than the vehicle. The object includes the charging device, the QR code, and the like.

Further, the standard data ID included in the vehicle data standardization data corresponds to a first data ID, and the standard data value included in the vehicle data standardization data corresponds to a first standard data value.

Further, the standard data ID included in the standardization data of the charging device data and the battery data corresponds to a second data ID, and the standard data value included in the standardization data of the charging device data and the battery data corresponds to second standardization data.

Further, the communication type information corresponds to the type information, the first cycle, the second cycle, and the third cycle correspond to a transmission cycle, the raw data ID included in the common formatted data of the vehicle data corresponds to a first raw data ID, and the raw data ID included in the common formatted data of the charging device data and the battery data corresponds to a second raw data ID.

Further, the raw data value included in the common formatted data of the vehicle data corresponds to a first raw data value, and the common formatted data of the vehicle data corresponds to first common data.

Further, the raw data value included in the common formatted data of the charging device data and the battery data corresponds to a second raw data value, and the common formatted data of the charging device data and the battery data corresponds to second common data.

As described above, the embodiment of the present disclosure is described, but the present disclosure is not limited to the above embodiment, and can be implemented with various modifications.

### First Modification

In the embodiment described above, the data processing device 1 is the smartphone. However, the data processing device 1 may be an in-vehicle device mounted on a vehicle.

### Second Modification

In the embodiment described above, the short-range wireless communication is performed by a manner conforming to the Wi-Fi standard or the BLE. However, it may be sufficient that the data processing device 1 can perform the wireless communication. For example, the wireless communication may be performed by a manner conforming to an UWB standard. The UWB is an abbreviation for Ultra Wide Band.

### Third Modification

In the embodiment described above, the QR code attached to the battery is read. However, the barcode attached to the battery may be read.

The controller 2 and the method thereof according to the present disclosure may be implemented by one or more dedicated computers. Such a dedicated computer may be provided by configuring a processor and a memory programmed to execute one or more functions embodied by a computer program. Alternatively, the controller 2 and the method thereof described in the present disclosure may be implemented by a dedicated computer provided by configuring a processor with one or more dedicated hardware logic circuits. Alternatively, the controller 2 and the method thereof described in the present disclosure may be implemented by one or more dedicated computers configured by a combination of a processor and a memory programmed to perform one or multiple functions and a processor configured with one or more hardware logic circuits. The computer program may be stored in a computer-readable non-transitory tangible storage medium as instructions to be executed by a computer. The method for implementing the functions of each portion included in the controller 2 does not necessarily need to include software, and all the functions may be implemented using one or multiple hardware circuits.

Multiple functions of one configuration element in the above-described embodiment may be implemented by multiple configuration elements, or one function of one configuration element may be implemented by multiple configuration elements. Multiple functions of multiple configuration elements may be implemented by one configuration element, or one function implemented by multiple configuration elements may be implemented by one configuration element. Further, a part of the configuration of the above embodiment may be omitted. At least a part of the configuration of the embodiment may be added to or replaced with another configuration of the embodiment.

In addition to the data processing device 1 described above, various features such as a system including the data processing device 1 as a configuration element, a program for causing the computer to function as the data processing device 1, a non-transitory tangible storage medium such as a semiconductor memory in which the program is stored, and a data processing method may provide to implement the present disclosure.

What is claimed is:

1. A data processing device comprising:
at least one of (i) a circuit and (ii) a processor with a memory storing computer program code executable by the processor, the at least one of the circuit and the processor configured to cause the data processing device to serve as:
a first acquisition portion configured to acquire first data that is data related to a vehicle by a preset first acquisition manner from the vehicle;
a second acquisition portion configured to acquire second data that is data related to an object other than the vehicle by a preset second acquisition manner from the object; and
a standardization processing portion configured to
generate first standardization data including a first data ID for identifying the first data acquired by the first acquisition portion and a first standard data value obtained by normalizing a value of the first data so that a same physical quantity of the first standard data value has a same value regardless of a vehicle type and a vehicle manufacture, and
generate second standardization data including a second data ID for identifying the second data acquired by the second acquisition portion and a second standard data value obtained by normalizing a value of the second data so that a same physical quantity of the second standard data value has a same value regardless of the vehicle type and the vehicle manufacture; and
a data storage configured to store the first standardization data and the second standardization data,
wherein
the at least one of the circuit and the processor is further configured to cause the data processing device to serve as a data transmission portion configured to transmit the first standardization data and the second standardization data stored in the data storage when a preset data transmission condition is satisfied for each of the first standardization data and the second standardization data.

2. The data processing device according to claim 1, wherein
the standardization processing portion is further configured to
determine whether each of the first data acquired by the first acquisition portion and the second data acquired by the second acquisition portion is dynamic data or static data, and
set type information indicating the dynamic data or the static data to the first standardization data and the second standardization data, and
the data transmission portion is further configured to transmit the first standardization data and the second standardization data when the data transmission condition set for each of the first standardization data and the second standardization data according to the type information is satisfied.

3. The data processing device according to claim 2, wherein
when the type information indicates the static data, the data transmission condition is set to transmit the first standardization data or the second standardization data after the first standardization data or the second standardization data that is a target of the data transmission condition is generated.

4. The data processing device according to claim 2, wherein
when the type information indicates the dynamic data, the data transmission condition is set to transmit the first standardization data or the second standardization data that is a target of the data transmission condition each time a preset transmission cycle elapses.

5. The data processing device according to claim 1, wherein
the first data acquired by the first acquisition portion includes a first raw data ID for identifying the first data,
the second data acquired by the second acquisition portion includes a second raw data ID for identifying the second data, and
the standardization processing portion is further configured to:
convert the first data acquired by the first acquisition portion into first common data including the first raw data ID and a first raw data value indicating a value of the first data;
convert the second data acquired by the second acquisition portion into second common data that is common data including the second raw data ID and a second raw data value indicating a value of the second data;
generate the first standardization data by normalizing the first raw data value included in the first common data; and
generate the second standardization data by normalizing the second raw data value included in the second common data.

6. The data processing device according to claim 5, wherein
the standardization processing portion is further configured to
determine whether each of the first data acquired by the first acquisition portion and the second data acquired by the second acquisition portion is dynamic data or static data, and
add type information indicating the dynamic data or the static data to the first common data and the second common data.

7. The data processing device according to claim 3, wherein
the data transmission condition is set to transmit the first standardization data or the second standardization data each time after the first standardization data or the second standardization data that is the target of the data transmission condition is generated.

8. The data processing device according to claim 3, wherein
the data transmission condition is set to prohibit transmission when a data value included in the first standardization data or the second standardization data that is the target of the data transmission condition does not change even in a case where the first standardization data or the second standardization data is generated.

9. A data processing method executed by a data processing device, the method comprising:
acquiring first data that is data related to a vehicle by a preset first acquisition manner from the vehicle;
acquiring second data that is data related to an object other than the vehicle by a preset second acquisition manner from the object;
generating first standardization data including a first data ID for identifying the acquired first data and a first standard data value obtained by normalizing a value of the first data so that a same physical quantity of the first standard data value has a same value regardless of a vehicle type and a vehicle manufacture, and
generating second standardization data including a second data ID for identifying the acquired second data and a second standard data value obtained by normalizing a value of the second data so that a same physical quantity of the second standard data value has a same value regardless of the vehicle type and the vehicle manufacture; and
transmitting the first standardization data and the second standardization data when a preset data transmission condition is satisfied for each of the first standardization data and the second standardization data.

10. A non-transitory tangible storage medium storing a program causing a computer to serve as:
a first acquisition portion configured to acquire first data that is data related to a vehicle by a preset first acquisition manner from the vehicle;
a second acquisition portion configured to acquire second data that is data related to an object other than the vehicle by a preset second acquisition manner from the object;
a standardization processing portion configured to
generate first standardization data including a first data ID for identifying the first data acquired by the first acquisition portion and a first standard data value obtained by normalizing a value of the first data so that a same physical quantity of the first standard data value has a same value regardless of a vehicle type and a vehicle manufacture, and
generate second standardization data including a second data ID for identifying the second data acquired by the second acquisition portion and a second standard data value obtained by normalizing a value of the second data so that a same physical quantity of the second standard data value has a same value regardless of the vehicle type and the vehicle manufacture;
a data storage configured to store the first standardization data and the second standardization data; and
a data transmission portion configured to transmit the first standardization data and the second standardization data stored in the data storage when a preset data transmission condition is satisfied for each of the first standardization data and the second standardization data.
